(19) United States
(12) Patent Application Publication
(10) Pub. No.: US 2021/0034998 A1
(43) Pub. Date: Feb. 4, 2021

(54) Quantum System and Method for Solving Bayesian Phase Estimation Problems

(71) Applicant: Zapata Computing, Inc., Boston, MA (US)

(72) Inventors: Yudong Cao, Cambridge, MA (US); Borja Peropadre, Somerville, MA (US); Jonathan P. Olson, Cambridge, MA (US)

(21) Appl. No.: 16/945,526

(22) Filed: Jul. 31, 2020

Related U.S. Application Data
(60) Provisional application No. 62/881,886, filed on Aug. 1, 2019.
(60) Provisional application No. 62/885,086, filed on Aug. 9, 2019.
(60) Provisional application No. 62/912,226, filed on Oct. 8, 2019.
(60) Provisional application No. 62/946,791, filed on Dec. 11, 2019.

(51) Int. Cl. G06N 7/00; G06N 10/00

(52) U.S. Cl. CPC G06N 7/005; G06N 10/00

(57) ABSTRACT

Embodiments of the present invention are directed to a hybrid quantum-classical (HQC) computer which includes a classical computer and a quantum computer. The HQC computer may perform a method in which: (A) the classical computer starts from a description of a initial problem and transforms the initial problem into a transformed problem of estimating an expectation value of a function of random variables; (B) the classical computer produces computer program instructions representing a Bayesian phase estimation scheme that solves the transformed problem; and (C) the hybrid quantum-classical computer executes the computer program instructions to execute the Bayesian phase estimation scheme, thereby producing an estimate of the expectation value of the function of random variables.

### BACKGROUND

In the past, Bayesian phase estimation has been limited to quantum computers which execute a circuit in a fault-tolerant manner. While theoretically offering a substantial increase in performance over classical computation, these schemes cannot produce a practical advantage due to the low coherence limitations of current quantum computers.

### SUMMARY

Recent advancements in theoretical tools for applying Bayesian phase estimation enable new methods for solving computational problems.

Embodiments of the present invention are directed to a hybrid quantum-classical (HQC) computer which includes a classical computer and a quantum computer. The HQC computer may perform a method in which: (A) the classical computer starts from a description of a initial problem and transforms the initial problem into a transformed problem of estimating an expectation value of a function of random variables; (B) the classical computer produces computer program instructions representing a Bayesian phase estimation scheme that solves the transformed problem; and (C) the hybrid quantum-classical computer executes the computer program instructions to execute the Bayesian phase estimation scheme, thereby producing an estimate of the expectation value of the function of random variables.

Other features and advantages of various aspects and embodiments of the present invention will become apparent from the following description and from the claims.

### BRIEF DESCRIPTION OF THE FIGURES

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention;

FIG. 3 is a diagram of a hybrid quantum-classical computer according to one embodiment of the present invention;

FIG. 4A is a dataflow diagram of a system implemented according to embodiment of the present invention;

FIG. 4B is a flowchart of a method performed by the system of FIG. 4A according to embodiment of the present invention; and

FIG. 5 is a diagram illustrating a matrix that captures correlations between feature vectors according to one embodiment of the present invention.

### DETAILED DESCRIPTION

Embodiments of the present invention are directed to a computer system which includes a classical computer and a quantum computer which perform a method in which: (A) the classical computer starts from a description of a problem and transforms the problem into a problem of estimating an expectation value of a function of random variables; (B) the classical computer produces computer program instructions representing a Bayesian phase estimation scheme that solves the problem of estimating an expectation value of a function of random variables generated in step 1; and (C) a hybrid quantum-classical computer executes the computer program instructions to execute the Bayesian phase estimation scheme, producing an estimate of the expectation value of the function of random variables.

Now that certain aspects of certain embodiments of the present invention have been described at a high level of generality, certain embodiments of the present invention will be described in more detail.

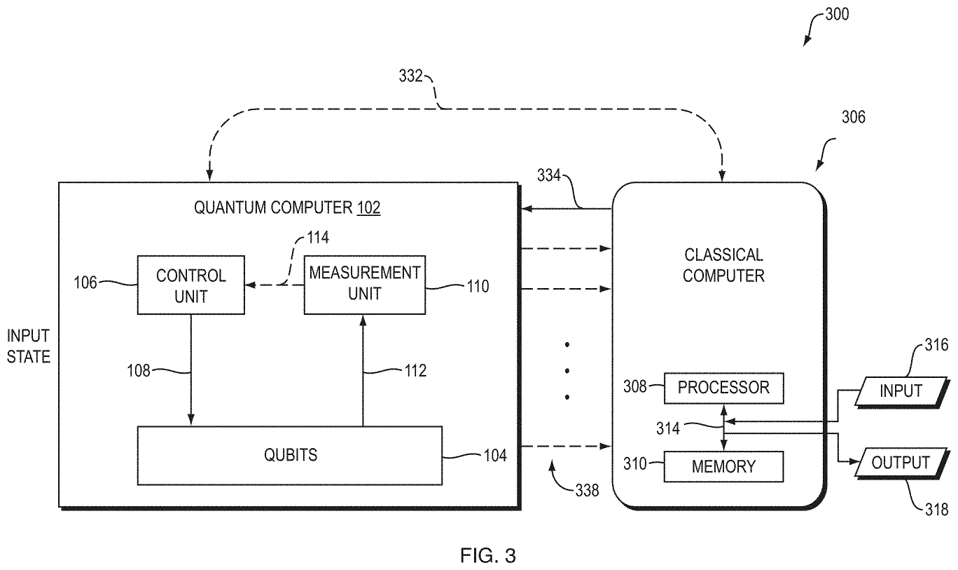

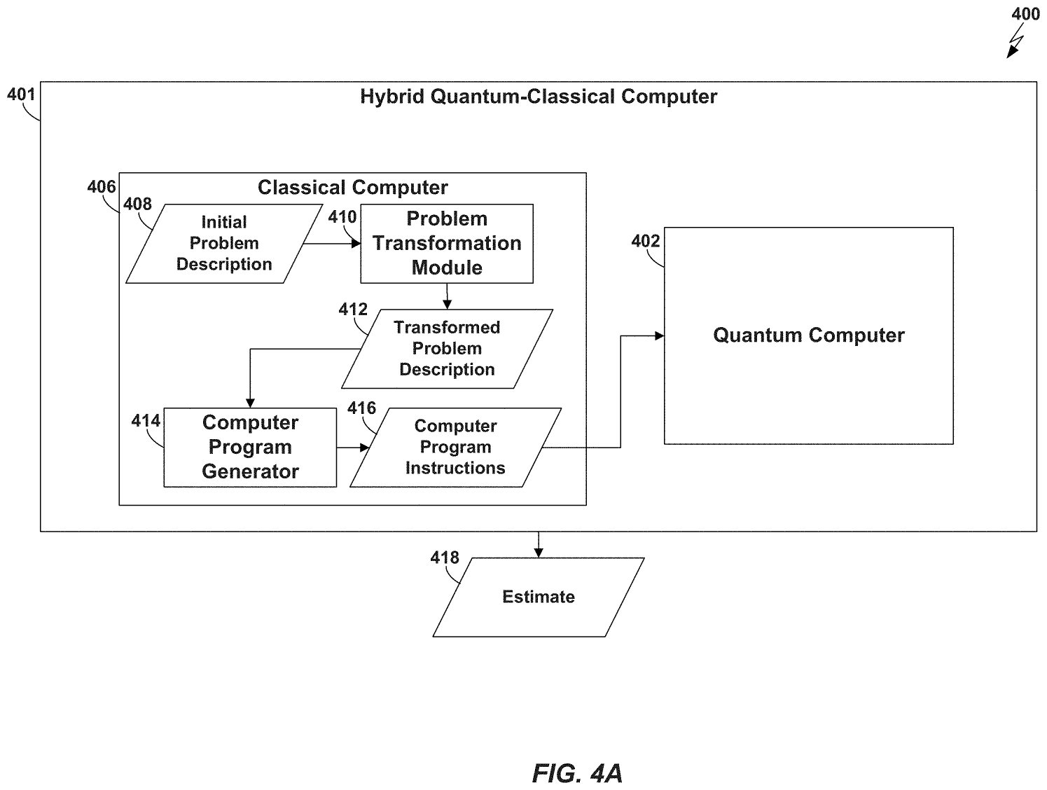

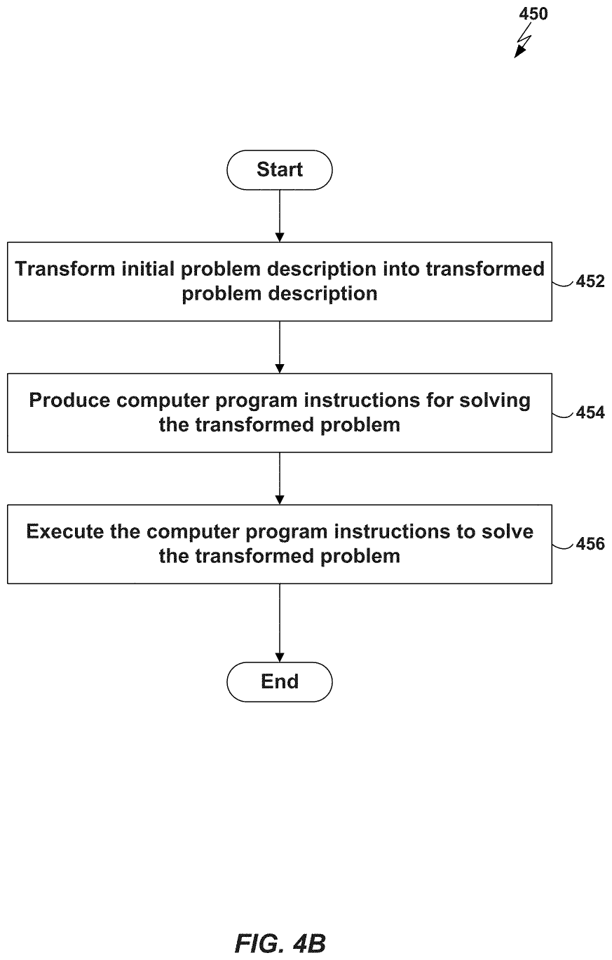

Referring to FIG. 4A, a dataflow diagram is shown of a system 400 implemented according to embodiment of the present invention. Referring to FIG. 4B, a flowchart is shown of a method 450 performed by the system 400 of FIG. 4A according to embodiment of the present invention. The system 400 includes a hybrid quantum-classical computer 401 which may, for example, have any of the properties disclosed herein in connection with the hybrid quantum-classical computer 300 of FIG. 3. The system 400 (e.g., the hybrid quantum-classical computer 401) includes a quantum computer 402 and a classical computer 406. Certain features disclosed herein as being part of, or performed by, the hybrid quantum-classical computer 401, may be part of, or performed by, solely the quantum computer 402, solely the classical computer 406, or by a combination of the quantum computer 402 and the classical computer 406.

The classical computer 406 includes (e.g., stores in at least one non-transitory computer-readable medium) an initial problem description 408 of an initial problem. Examples of such an initial problem are described below. The initial problem may, for example, not be a problem of estimating an expectation value of a function of random variables. The initial problem description 408 may, for example, be or include data representing the initial problem.

The classical computer 406 includes a problem transformation module 410 which transforms the initial problem description 408 into a transformed problem description 412 of a transformed problem of estimating an expectation value of a function of random variables (FIG. 4B, operation 452). The transformed problem description 412 may, for example, be or include data representing the transformed problem. The classical computer 406 may, for example, store the transformed problem description 412 in at least one non-transitory computer-readable medium. The problem transformation module 410 may, for example, receive the initial problem description 408 as input and generate the transformed problem description 412 based on the initial problem description 408. Transforming the initial problem description 408 into the transformed problem description may include, for example, transforming the initial problem description into a transformed problem description representing a single transformed problem, or into a transformed problem description representing multiple transformed subproblems that involve evaluations of expectation values.

In some embodiments, the method 450 does not include operation 452, and the classical computer 406 does not include the initial problem description 408 and the problem transformation module 410. The classical computer 406 may, for example, store the transformed problem description 412 without operation 452 and without the initial problem description 408 and problem transformation module 410. For example, the classical computer 406 may receive the transformed problem description 412 from a source external to the classical computer 406 (e.g., from another computer external to the hybrid quantum-classical computer 401) and store the received transformed problem description 412. The transformed problem description 412 may, but need not, have been generated externally to the hybrid quantum-classical computer 401 before the transformed problem description 412 was received by the classical computer 406, such as by transforming the initial problem description 408 into the transformed problem description 412 externally to the hybrid quantum-classical computer 401.

The classical computer 406 may also include a computer program generator 414, which receives the transformed problem description 412 as input, and which generates computer program instructions 416 representing a Bayesian phase estimation scheme for solving the transformed problem represented by the transformed problem description 412 (FIG. 4B, operation 454). The classical computer 406 may, for example, store the computer program instructions 416 in at least one non-transitory computer-readable medium.

The Bayesian phase estimation scheme may take any of a variety of forms, such as the following. One variant of amplitude estimation explores the tradeoff between circuit depth and error; namely, with the limited quantum coherence that can be afforded on NISQ devices, one uses only as deep of a circuit as is beneficial to accelerate the amplitude estimation process. This may be accomplished using a Bayesian variant of phase estimation: The process starts from a prior distribution P(α) of the possible values of the amplitude, followed by running a (shallow) phase estimation circuit C on a NISQ device, obtaining measurement outcome d∈{0,1}. The circuit C is parametrized by the number m of controlled unitary operations that are applied. The process then computes the posterior distribution P(α|d,m) incorporating the measurement outcome. For the next iteration, the process chooses m such that the expected posterior variance with respect to the distribution over the measurement outcome d is minimized. For NISQ devices, it is entirely feasible to assume that m takes value from a small set of numbers such as {1, 2, 3}. The maximum value of m is restricted by the gate depth that can be afforded by the device. The higher the maximal value, the more asymptotic speedup one reaps with respect to classical sampling approaches.

In some embodiments, the method 450 does not include operation 454, and the classical computer 406 does not include the transformed problem description 412 and the computer program generator 414. The classical computer 406 may, for example, store the computer program instructions 416 without operation 454 and without the transformed problem description 412 and computer program generator 414, in which case the classical computer 406 may also not include the initial problem description 408 and problem transformation module 410, as described above. For example, the classical computer 406 may receive the computer program instructions 416 from a source external to the classical computer 406 (e.g., from another computer external to the hybrid quantum-classical computer 401) and store the received computer program instructions 416, in which case the classical computer 406 may (but need not) also receive the transformed problem description 412 from a source external to the classical computer 406.

The hybrid quantum-classical computer 401 executes the computer program instructions 416 to execute the Bayesian phase estimation scheme to produce an estimate 418 of the expectation value of the function of random variables (FIG. 4B, operation 456). Although the estimate 418 is shown in FIG. 4B as being external to the hybrid quantum-classical computer 401, this is merely an example and not a limitation of the present invention. For example, the estimate 418 may be stored in at least one non-transitory computer-readable medium, such as within the classical computer 406.

The Bayesian phase estimation scheme may be executed in any of a variety of ways, such as the following. One step that may be performed by embodiments of the present invention is quantum amplitude estimation. The goal of amplitude estimation is to estimate the amplitude α of a particular subspace X in a given state |φ [symbol] that can be generated by operation A|0 [symbol] =|φ [symbol] =α|φ_{X} [symbol] +β|φ^{⊥}) where |φ_{X} [symbol] is the sum of components of |φ [symbol] in X and |φ^{⊥}) is the sum of components in the orthogonal complement of X. In addition to A there is an operator G that applies a phase −1 on any state in X but acts as an identity on the orthogonal complement of X. Using the ability to perform A it is possible to generate a reflection with respect to |φ [symbol] by composing the operation A^{†}R₀A where R₀ is a reflection operator with respect to |0 [symbol] state. The amplitude α may then be extracted from the phases of the eigenvalues of the unitary operator A^{†}R₀AG.

Operation 454 may include incorporating, into the Bayesian phase estimation scheme, a model for an effect of error on the hybrid quantum-classical computer 401.

The initial problem description 408 may, for example, include a description of a Monte Carlo sampling problem, and operation 452 may include transforming the description of the Monte Carlo sampling problem into the transformed problem description 412. The initial problem description 408 may include a description of a problem of credit valuation adjustment, and operation 452 may include transforming the description of the Monte Carlo sampling problem into the transformed problem description 412.

Operation 452 may include encoding the initial problem description via a binary encoding. The initial problem description 408 may include a description of a travelling salesman problem, and operation 452 may include transforming the description of the travelling salesman problem into the transformed problem description 412.

The initial problem description 408 may include a description of a quadratic unconstrained binary optimization problem, and operation 452 may include transforming the description of the quadratic unconstrained binary optimization problem into the transformed problem description 412. The initial problem description 408 may include a description of a problem of feature selection, and operation 452 may include transforming the description of the quadratic unconstrained binary optimization problem into the transformed problem description 412. Operation 456 may include: (C)(1) at the quantum computer 402, computing, using a distance measure, a distance between two data arrays; (C)(2) at the quantum computer 402, constructing an Ising Hamiltonian whose ground state encodes a minimally redundant subset with respect to the distance measure; and (C)(3) obtaining the optimal subset. Obtaining the optimal subset may be performed by the quantum computer 402 and not the classical computer 406. Alternatively, for example, obtaining the optimal subset may be performed by the classical computer 406 and not the quantum computer 402.

Having described certain embodiments of the present invention at a high level of generality, examples of particular embodiments of the present invention will now be described in more detail.

### Example 1: Monte Carlo Sampling

Credit valuation adjustment or CVA is formally defined as the difference between a risk-free portfolio value and the true portfolio value that takes into account the possibility of counterparty default. At a high level, the legacy classical method to estimate CVA relies on complex Monte Carlo (MC) simulations. As it is commonplace in quantitative finance, MC simulations are used to simulate the different possible paths of the financial instrument at hand. On top of this simulation, a second MC algorithm is utilized to simulate the stochastic defaulting process. While efficient from the computer science standpoint, this nested MC method is very intensive computationally, for the number of samples required to get a certain precision scales very fast with the error. To make this more tractable computationally tractable, approximations techniques can be used either in the MC simulation (example of this are least-square MC (lsMC), or Markov-chain MC or McMC), or in the derivative pricing model (examples of this would be European option with constant volatility, modelled by the Black-Scholes equation, or more complex models like Hull-White model). However, this could compromise the precision of the solution for the credit risk valuation.

Credit Valuation adjustment is a sampling problem. In the special case of unilateral CVA, only the counterparty has the potential to default and the institution is assumed to be risk-free. In this situation, CVA can be defined as the risk-neutral expectation of the discounted exposure

$$CVA = ( 1 - R ) {\int }_{0}^{T} {𝔼}_{Q} [ \frac{{B}_{0}}{{B}_{τ}} E ( τ ) \vert τ = t ] {dP}_{D} ( 0 , t ) , \qquad ( 1 )$$

where R is the recovery constant factor that the institution, and B₀/Bₜ accounts for the present value of one unit of the base currency invested today at the prevailing interest rate for maturity t. E(t) is the expected exposure, and is defined as the sum of contract values Vₜⁱ over all the portfolio, at the time of maturity t: E(t)=Σᵢ₌₁^{N}max{Vₜⁱ,0}. P_{D}(t₁,t₂) is the probability of counterparty default between times t₁ and t₂. As it is clear from Eq. (1), the general CVA scenario contemplates that the expectation value of the expected exposure is correlated with the counterparty default occurring at time t. However, for the case of interest-rate derivative transactions, it is safe to assume that these two variables are uncorrelated.

The problem may be described as multiple subproblems that involve evaluations of expectation values of the form [symbol] ₚ(ƒ(X))=Σᵢ₌₀²^{ⁿ}⁻¹pᵢƒ(i) where the function ƒ:{0,1}ⁿ→[0,1] and where p is a discrete probability distribution over n-bit strings. The problem of estimating [symbol] ₚ(ƒ(X)) may then be addressed using amplitude estimation. The formulation of CVA above involves nested sums and expectations. This may also be addressed using a moderate qubit overhead, by taking advantage of the tensor product structure of joint quantum states of multiple systems. In this scenario, it is not difficult to show that CVA can be cast into a nested MC problem. This is shown by approximate the time integral in Eq (1) by a discrete sum over default events. Under this assumption Eq (1) can be written as:

$$CVA = ( 1 - R ) {\sum }_{j = 1}^{K} {P}_{D} ( {t}_{j} ) {\sum }_{i = 1}^{N} {𝔼}_{Q} [ \frac{{B}_{0}}{{B}_{{t}_{i}}} max \{ {V}_{t}^{i} , 0 \} ] , \qquad ( 2 )$$

The defaulting events Σⱼ₌₁^{K}P_{D}(tⱼ) can be simulated via a stochastic process, such as discrete random walks, or directly from the term structure of credit-default swap spreads. Thus, the values P_{D}(tⱼ) are drawn of the probability distribution P_{D}={P_{D}(tⱼ)}ⱼ₌₁^{K}, and so CVA can be rewritten as a nested expected value

$$CVA = {\sum }_{i = 1}^{N} {𝔼}_{Q} [ {𝔼}_{{P}_{D}} [ \frac{{B}_{0}}{{B}_{{t}_{i}}} max \{ {V}_{t}^{i} , 0 \} ] ] . \qquad ( 3 )$$

The standard crude Monte Carlo approach to compute CVA, which is being used in practice (and it is known as nested Monte Carlo in the literature, estimates the independent CVAs, based on a time-discretized summation approximation of the integral (as described in Eq. (3)), and Monte Carlo estimation of expected exposures. The number of samples required to simulate CVA up to an error E scales as

$$𝒪 ( \frac{{var}_{1}^{2} \times {var}_{2}^{2}}{{ϵ}^{4}} ) ,$$

where var is the variance associated to each of the MC simulations.

We now describe examples of the transformation of the problem for this example.

The goal of CVA is to evaluate the sum which is a discrete approximation of the expression in (3):

$$= {\sum }_{i = 1}^{M} \frac{1}{2} [ EE ( {t}_{i - 1} ) P ( {t}_{i - 1} ) + EE ( {t}_{i} ) P ( {t}_{i} ) ] q ( {t}_{i} ) = - Δ + {\sum }_{i = 1}^{M} EE ( {t}_{i} ) P ( {t}_{i} ) q ( {t}_{i} ) \qquad ( 4 )$$

where P(t)=e^{-rt} is the risk-free discount factor with interest rate r at time t, Δ=½[EE(t₀)P(t₀)+EE(t_{M})P(t_{M})] is an easy-to-compute shift, qᵢ is the probability of default at time tᵢ and EE(t)= [symbol] v(x,t) is the expected exposure with

$$v ( x , t ) = max \{ {e}^{- \frac{{σ}^{2}}{2} t + x σ \sqrt{t}} - K , 0 \}$$

being the payoff at time t, assuming the underlying asset is a single European option. The case of multiple underlying assets can be generalized in a relatively straightforward way. Let \tilde{v}(x,t):{0,1}ₙ×{0,1}^{m}→{0,1}^{k} where n=┌log N┐ is the number of bits needed for specifying the unit normal random variable, m=┌log(M+1)┐ is the number of bits needed for specifying time, k=┌log K┐ is the number of bits used for describing the output value v(x,t).

From Equation (4) it is clear that for [symbol] it suffices to estimate the quantity

$${\sum }_{i = 1}^{M} EE ( {t}_{i} ) P ( {t}_{i} ) q ( {t}_{i} ) \approx {\sum }_{i = 1}^{M} {\sum }_{j = 1}^{N} p ( {x}_{j} ) \tilde{v} ( {x}_{j} , {t}_{i} ) P ( {t}_{i} ) q ( {t}_{i} ) . \qquad ( 5 )$$

We now describe examples of the computer program instructions of the problem for this example.

Let quantum operator Gₚ acting on n qubits be such that

$${G}_{p} \vert {0}^{n} 〉 = {\sum }_{j} \sqrt{p ( {x}_{j} )} \vert j 〉$$

with p(xⱼ) being the probability function of the unit normal random variable, discretized to be defined on points {xⱼ}. Here |j [symbol] is the computational basis state marking the index i in its binary form. The setting of p being the unit normal distribution is a consequence of choosing the geometric Brownian model as the statistical model for the underlying asset. A different distribution may be chosen for other statistical models. For example, in cases where one would like to contemplate distributions with heavy tails, Lévy distribution may be used.

Similarly, we let quantum operator R_{q} acting on n+1 qubits be such that

$${R}_{q} \vert i 〉 \vert 0 〉 = {\sum }_{i} \vert i 〉 ( \sqrt{1 - q ( {t}_{i} )} \vert 0 〉 + \sqrt{q ( {t}_{i} )} \vert 1 〉 )$$

with q(tᵢ) being the probability of default at time tᵢ.

Define quantum operator R_{P} acting on n+1 qubits such that

R_{P}|i [symbol] |0 [symbol] =|i [symbol] (\sqrt{1−P(tᵢ)}|0 [symbol] +\sqrt{P(tᵢ)}|1 [symbol] )

Define quantum operator Rᵥ acting on n+m+1 qubits such that

Rᵥ|i [symbol] |j [symbol] |0 [symbol] =|i [symbol] |j [symbol] (\sqrt{1−\tilde{v}(xⱼ,tᵢ)}|0 [symbol] +\sqrt{\tilde{v}(xⱼ,tᵢ)}|1 [symbol] )

We could then describe an algorithm for estimating the quantity in (5) as the following:

Start with two quantum registers, one of m qubits and the other of one qubit, in state

$$( \frac{1}{\sqrt{M}} {\sum }_{i = 0}^{M - 1} \vert i 〉 ) ⊗ \vert 0 〉 .$$

Apply the operation R_{P} on the state, generating the superposition

$$\frac{1}{\sqrt{M}} {\sum }_{i = 0}^{M - 1} \vert i 〉 ( \sqrt{1 - P ( {t}_{i} )} \vert 0 〉 + \sqrt{P ( {t}_{i} )} \vert 1 〉 ) .$$

Add a third quantum register of n qubits and prepare it in the state

$${\sum }_{j = 0}^{N - 1} \sqrt{p ( {x}_{j} )} \vert j 〉$$

using the operator G_{P}.

Add a fourth quantum register of one qubit in |0 [symbol] and apply the operator Rᵥ onto the first, third and the fourth register to produce an entangled state between the four registers

$$\frac{1}{\sqrt{M}} {\sum }_{i = 0}^{M - 1} \vert i 〉 ( \sqrt{1 - P ( {t}_{i} )} \vert 0 〉 + \sqrt{P ( {t}_{i} )} \vert 1 〉 ) {\sum }_{j = 0}^{N - 1} \sqrt{p ( {x}_{j} )} \vert j 〉 ( \sqrt{1 - \tilde{v} ( {x}_{j} , {t}_{i} )} \vert 0 〉 + \sqrt{\tilde{v} ( {x}_{j} , {t}_{i} )} \vert 1 〉 )$$

Add a fifth quantum register of one qubit in |0 [symbol] and apply the operator R_{q} onto the first and the fifth register of the state above to produce the final state

$$\vert χ 〉 = \frac{1}{\sqrt{M}} {\sum }_{i = 0}^{M - 1} \vert i 〉 ( \sqrt{1 - P ( {t}_{i} )} \vert 0 〉 + \sqrt{P ( {t}_{i} )} \vert 1 〉 ) {\sum }_{j = 0}^{N - 1} \sqrt{p ( {x}_{j} )} \vert j 〉 ( \sqrt{1 - \tilde{v} ( {x}_{j} , {t}_{i} )} \vert 0 〉 + \sqrt{\tilde{v} ( {x}_{j} , {t}_{i} )} \vert 1 〉 ) ( \sqrt{1 - q ( {t}_{i} )} \vert 0 〉 + \sqrt{q ( {t}_{i} )} \vert 1 〉 )$$

Let Π₁₁₁ be projector onto the subspace where the second, fourth and fifth registers are all in the state |1 [symbol] . More explicitly, we have

$${Π}_{111} = ( \frac{I - Z}{2} ) ⊗ ( \frac{I - Z}{2} ) ⊗ ( \frac{I - Z}{2} ) = \frac{1}{8} ( I - {Z}_{2} - {Z}_{4} - {Z}_{5} + {Z}_{2} {Z}_{4} + {Z}_{2} {Z}_{5} + {Z}_{4} {Z}_{5} - {Z}_{2} {Z}_{4} {Z}_{5} )$$

which is a linear combination of three operators that can be measured directly (also simultaneously) on the quantum processor. Finally, we observe that the quantity desired in Equation (5) can be obtained by

$${\sum }_{i = 1}^{M} {\sum }_{j = 1}^{N} p ( {x}_{j} ) \tilde{v} ( {x}_{j} , {t}_{i} ) P ( {t}_{i} ) q ( {t}_{i} ) = 〈 χ \vert {Π}_{111} \vert χ 〉 .$$

Executing the computer program instructions can be estimated to error ϵ in time O(1/ϵ) using amplitude estimation, being quadratically faster than the classical case which is O(1/ϵ²).

Other features and advantages of various aspects of Monte Carlo sampling problems will become apparent from the above description and from the claims.

### Example 2: Hamiltonian Problems

Quantum computers have been suggested as a heuristic for solving NP-hard problems. The traveling salesman problem is a famous instance of such a problem, which commonly receives attention because of its application in logistics settings. However, implementations of the traveling salesman problem on quantum computers are limited by the number of qubits necessary to encode a solution. Since the development of NISQ computers, only Hamiltonians that encode the solution in N\hat{ }2 qubits or more have been known.

Certain embodiments of the present invention are directed to a hybrid classical quantum computer (HQC) which computes an optimal or near-optimal solution to the traveling salesman problem (TSP) with N vertices on a system of only N*log(N) qubits, thereby drastically reducing the quantum resources to solve this and related problems (such as the vehicle routing problem). The best previous construction of the traveling salesman problem on a quantum computer requires N\hat{ }2 qubits to encode the solution into the Hamiltonian.

We now describe examples of the transformation of the problem for this example.

The Lucas formulation of the traveling salesman problem (TSP) uses a unary encoding requiring N² qubits, where N is the number of vertices of a graph. In this encoding, a candidate route is encoded by having |1 [symbol] in the (i+jN)^{th} qubit, indicating that the i^{th} vertex should be the j^{th} destination in the route. For example, consider a 4-vertex route whose solution is 1→3 →2→0. The Lucas formulation would encode this solution in the qubit string:

|ψₛₒₗ^{lucas} [symbol] =10010100001000001)

Embodiments of the present invention are directed to reformulate this in a binary encoding such that the values of the j^{th} set of log(N) qubits indicate, in binary, the j^{th} destination in the route. In this example, the new formulation encodes the solution into the string:

|ψₛₒₗ [symbol] =101111000

[symbol]

This binary encoding uses N·┌log₂N┐ qubits. The corresponding Hamiltonian for this encoding, which is 2┌log₂N┐-body and has fewer terms than the Lucas formulation.

Typical Hamiltonian encodings for optimization problems, including the traveling salesman problem (TSP) are written in the form

H═H_{A}+H_{B}

where H_{A} corresponds to a solution of the Hamiltonian path problem (i.e. a route that spans the entire graph and does not repeat vertices) and H_{B} corresponds to the total length of each route. An optimal traveling salesman route is found by a Hamiltonian path with minimal total distance between vertices.

### Embodiments of the Present Invention

reformulate the Hamiltonian so as to be consistent with the ground state being the optimal route. The Lucas formulation defines:

$${H}_{A} = A {\sum }_{v = 1}^{N} {( 1 - {\sum }_{j = 1}^{N} {x}_{v , j} )}^{2} + A {\sum }_{j = 1}^{N} {( 1 - {\sum }_{v = 1}^{N} {x}_{v , j} )}^{2} + A {\sum }_{( uv ) ∉ E} {\sum }_{j = 1}^{N} {x}_{u , j} {x}_{v , j + 1}$$

H_{A} consists of three terms. The first places an energy penalty on any path which does not have each and every vertex uniquely included in the path (i.e. the path spans the entire space and does not repeat vertices).

The second term places an energy penalty on assignments which have multiple (or zero) vertices for a given destination of the route. This term is not needed in the embodiments of the present invention are directed to because there is, by construction, only a single vertex assigned to each destination of the route.

The third term places an energy penalty on routes which include edges that are not included in the graph. This term is relevant for the Hamiltonian path problem, but effectively irrelevant for the traveling salesman; this is because any energy penalty for non-edges (uv)∉E could be included by assuming a complete graph, while assigning very large weights to these non-edges in H_{B}. However, embodiments of the present invention may use this term for other similar applications.

The Lucas formulation of H_{B} is,

$${H}_{B} = B {\sum }_{( uv ) ∈ E} {W}_{uv} {\sum }_{j = 1}^{N} {x}_{u , j} {x}_{v , j + 1}$$

Note that the outer sum encodes the distance between each edge of the cycle, while the inner sum is simply “1” if u and v are neighboring vertices in the route, and otherwise “0”.

Embodiments of the present invention utilize an equivalent term for x_{u,j}. In this formalism, y_{d}_{ᵢ}_{,j} the digit representing the i^{th} binary digit of the vertex in the j^{th} position of the route,

|ψ [symbol] =|y_{1,0}y_{0,0}y_{1,1}y_{0,1}y_{1,2}y_{0,2}y_{1,3}y_{0,3}

[symbol]

Embodiments of the present invention utilize the binary form of u as u=uₖuₖ₋₁ . . . u₁u₀ where k=┌log N┐−1. Because there is no qubit in the new formalism defined specifically to encode u and j, the equivalent term becomes

x_{u,j} [symbol] y|_{0,j}^{u} . . . y|_{k,j}^{u}

where y|_{i,j}^{u} is defined as,

$$y {\vert}_{i , j}^{u} = \{ \begin{matrix}1 - {y}_{{d}_{i} , j} , & {u}_{i} = 0 \\ {y}_{{d}_{i} , j} , & {u}_{i} = 1\end{matrix}$$

Simply, y|_{i,j}^{u} is a “1” if y_{d}_{ᵢ}_{,j}=uᵢ and “0” otherwise. Thus, the product y|_{0,j}^{u} . . . y|_{k,j}^{u}=1 if and only if each binary digit of u is the same value as the qubits in the j register, and “0” otherwise. In other words, identical to the behavior of x_{u,j}, this product of terms registers a “1” when the |ψ [symbol] includes u as the j^{th} destination of the route.

Note that we could also represent the above mapping as x_{u,j} [symbol] Πᵢ₌₀^{k}(y_{d}_{ᵢ}_{,j})^{u}^{ᵢ}(1−y_{d}_{ᵢ}_{,j})^{1-u}^{ᵢ}.

We can now replace the Hamiltonian H_{B} with

$${H}_{B}^{new} = B {\sum }_{( uv ) ∈ E} {W}_{uv} {\sum }_{j = 1}^{N} {\prod }_{i = 0}^{k} y {\vert}_{i , j}^{u} y {\vert}_{i , j + 1}^{v} \\ or$$

$${H}_{B}^{new} = B {\sum }_{( uv ) ∈ E} {W}_{uv} {\sum }_{j = 1}^{N} {\prod }_{i = 0}^{k} {( {y}_{{d}_{i} , j} )}^{{u}_{i}} {( 1 - {y}_{{d}_{i} , j} )}^{1 - {u}_{i}} {( {y}_{{d}_{i} , j + 1} )}^{{v}_{i}} {( 1 - {y}_{{d}_{i} , j + 1} )}^{1 - {v}_{i}} .$$

and similarly, with x_{v,j} in H_{A}.

Note as stated earlier, this Hamiltonian is 2┌log₂ N┐-body, has the same number of terms in H_{B}, and fewer terms in H_{A}.

The term y|_{i,j}^{u} may also appear in variants of the traveling salesman problem, the vehicle routing problems and its variants, and a myriad of other graph problems with constraints of the same form.

We now describe examples of producing the computer program instructions for this example. Once a Hamiltonian for the problem has been produced, any number of known methods to construct a phase estimation problem may be utilized. For instance, a controlled unitary of the form U=e^{-iHt} may be created and applied with the control on a single qubit which is proceeded and preceded by a Hadamard gate. Alternatively, the problem Hamiltonian may be broken into individual terms and estimated by summing them.

The execution of the program for this example may, for example, be carried out in any of the ways disclosed herein, such as by using quantum amplitude estimation as described herein.

### Example 3: Optimization Problems

One of the emerging challenges in artificial intelligence (AI) is to identify, from a vast quantity of data having a multitude of features, a subset of features that are most relevant for a given learning task. Currently this challenge typically is addressed manually using human intuition, relying on domain knowledge related to the nature of the data at hand. The success of this approach often is limited in cases in which a vast number of features are concerned. For example, in the case of a data set with 1000 features (a relatively small number in practice), there are roughly 2¹⁰⁰⁰ possible subsets of features, while there are only estimated 2³⁰⁰ hydrogen atoms in the observed Universe. Therefore, it is clear that this is a problem for which a brute force search approach quickly becomes intractable for even moderately sized problems.

Embodiments of the present invention are directed to a system which identifies—from a large quantity of data having a plurality of features—a subset of features that are more relevant for a given learning task. The computer system identifies the feature subset efficiently even when the number of the plurality of features is large and when a brute force search approach would, therefore, be infeasible.

We now describe examples of the transformation of the problem for this example.

The goal of feature selection is to determine, among a given set of features, a subset of features that are most relevant to a given classification goal and also the least redundant with each other. This problem may, for example, be rephrased as a quadratic (non-linear) unconstrained binary optimization (QUBO) problem, such as

$${min}_{s ∈ {\{ 0 , 1 \}}^{M}} \frac{1}{2} α {s}^{T} Qs - ( 1 - α ) {f}^{T} s .$$

In the above, the binary vector s∈{0,1}^{M} encodes the choice for the subset of features, with sᵢ=1 if the i-th feature is selected, and sᵢ=0 otherwise. The QUBO problem is equivalent to solving MAX-CUT on a weighted complete graph over M nodes. The optimization problem is NP-Complete, rendering it computationally intractable to find the global optimum for large M in the worst case. MAX-CUT on degree-3 graph is an NP-complete variant that has been well-studied in the literature for the regime where QAOA may offer a quantum advantage over classical algorithms, such as Goermans-Williamson. However, embodiments of the present invention include a variant of MAX-CUT on graphs whose degree scales as the number of nodes, which makes it much harder to solve than degree-3 instances in general. Investigating the power of QAOA on these instances is by itself valuable for its practical relevance.

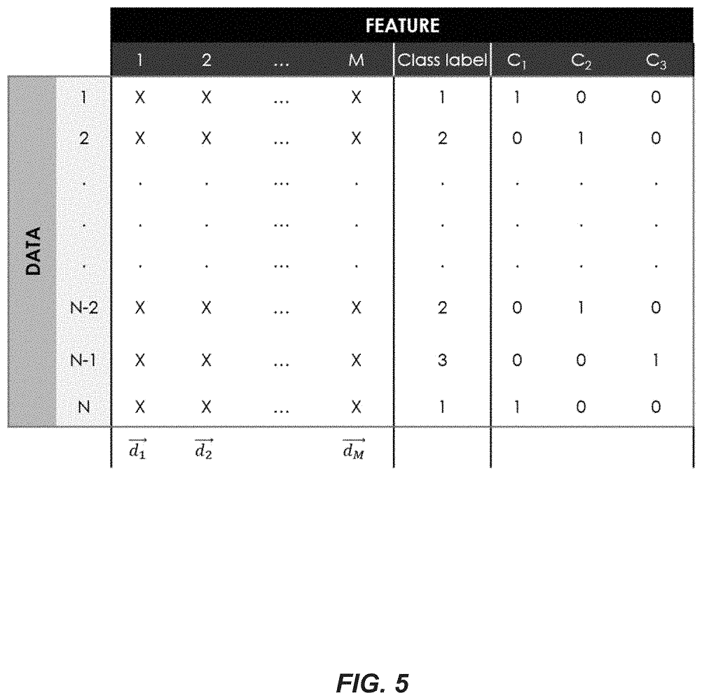

The matrix Q captures the correlations between feature vectors \vec{d}ᵢ (see FIG. 5 for definition). For example, its element (i,j) can be defined as the Pearson correlation coefficients

$${Q}_{ij} = \vert {ρ}_{ij} \vert = \vert \frac{cov ( \vec{{d}_{l}} , \vec{{d}_{J}} )}{var ( \vec{{d}_{l}} ) var ( \vec{{d}_{J}} )} \vert$$

where cov stands for covariance between two vectors and var is the standard deviation of a given vector. In other formulations, one could also consider mutual information:

Qᵢⱼ=I(\vec{dᵢ},\vec{dⱼ})=H(\vec{dᵢ})+H(\vec{dᵢ})−H(\vec{dᵢ},\vec{dⱼ})

where H(\vec{v})=Σᵢ₌₁ⁿvᵢ log vᵢ is the entropy of a vector \vec{v} whose elements are normalized to be between 0 and 1. The matrix element Qᵢⱼ is essentially the magnitude of the Pearson correlation coefficient. Hence minimizing the first term s^{T}QS in the objective function will yield a subset of features that are least correlated, and therefore least redundant, with each other.

The second term in the optimization problem (corresponding to the vector f) represents a subset of features that are most relevant to the prediction of a class label for a given model. Hence minimizing the second term −f^{T}s (or equivalently maximizing the term f^{T}s) translates to determining the labels which the model accurately predicts. This model could correspond to labels generated by a classical classifier, such as a support vector machine (SVM), or labels generated from a quantum classifier.¹ ¹ See, e.g., M. Schuld, A. Bocharov, K. Svore, N. Wiebe, 2018, arXiv:1804.00633 [quant-ph].

For instance, the vector f may incorporate the information of a classifier with respect to each feature i according to:

$${f}_{i} = {\sum }_{k = 1}^{C} {p}_{k} \vert {ρ}_{{iC}_{k}} \vert$$

where for each possible label k we define Cₖ as a binary mask for the given classifier, be it quantum or classical.

Here, Cₖ=1 if the classifier predicts the label k on a data point and Cₖ=0 otherwise. Alternatively, in the mutual information formulation we can also have:

$${f}_{i} = {\sum }_{k = 1}^{C} {p}_{k} I ( \vec{{d}_{l}} , \vec{{C}_{k}} )$$

where the vector \vec{Cₖ}is a 0-1 vector with elements defined as above.

We now describe certain examples of producing the computer program instructions for this example. Since the goal of feature selection is to find a subset of features that is both maximally relevant and minimally redundant, we construct the objective function as above with a weighting coefficient α that tunes the balance between relevance and redundancy. Some heuristic methods exist in the literature for this approach.² ² See, e.g., Irene Rodriguez-Lujan, Ramon Huerta, Charles Elkan, Carlos Santa Cruz. The Journal of Machine Learning Research. Volume 11, Mar. 1, 2010. Pages 1491-1516.

We now describe certain examples of executing the computer program instructions for this example. The QAOA circuit for solving the QUBO problem consists of M qubits and p layers. Each qubit corresponds to one feature, with 0 meaning non-selection and 1 meaning selection. The circuit starts with an even superposition of all possible 2^{M} states. Each layer of the circuit consists of two steps: 1) evolution under the “problem” Hamiltonian H=Σ_{i,j}Qᵢⱼσᵢ^{z}σⱼ^{z}+Σᵢ₌₁^{M}fᵢσᵢ^{z} for a specified time γ; 2) evolution under a “mixer” Hamiltonian such as Σᵢ₌₁^{M}σᵢ^{x} for a specified time β. During training, the parameters {(γ₁,β₁), (γ₂,β₂), . . . , (γₚ,βₚ)} are tuned such that the expected energy of the output state with respect to H is minimized. The outcomes of measuring the output state will indicate the solution to the QUBO problem.

Distance measure using quantum kernel. In the above discussion, the correlation between data arrays are computed using common metrics such as Pearson correlation coefficients and mutual information. Using quantum computation one could also compute distance measures that are fundamentally intractable using classical computers. Note that the state vector for n qubits is of dimension 2ⁿ. For two data arrays \vec{p} and \vec{q}, we each use a parametrized quantum operation Uₚ and U_{q} to encode the arrays into quantum states |p [symbol] =Uₚ|0 [symbol] and |q [symbol] =U_{q}|0 [symbol] respectively. On a classical computer, computing | [symbol] p|q [symbol] |² is tractable only for n not beyond 60. However, on a quantum computer this can be efficiently evaluated in poly(n) time. This allows for a form of feature selection which is fundamentally beyond what is capable on classical devices.

Other features and advantages of various aspects and embodiments of the present invention will become apparent from the prior description and from the claims.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Various physical embodiments of a quantum computer are suitable for use according to the present disclosure. In general, the fundamental data storage unit in quantum computing is the quantum bit, or qubit. The qubit is a quantum-computing analog of a classical digital computer system bit. A classical bit is considered to occupy, at any given point in time, one of two possible states corresponding to the binary digits (bits) 0 or 1. By contrast, a qubit is implemented in hardware by a physical medium with quantum-mechanical characteristics. Such a medium, which physically instantiates a qubit, may be referred to herein as a “physical instantiation of a qubit,” a “physical embodiment of a qubit,” a “medium embodying a qubit,” or similar terms, or simply as a “qubit,” for ease of explanation. It should be understood, therefore, that references herein to “qubits” within descriptions of embodiments of the present invention refer to physical media which embody qubits.

Each qubit has an infinite number of different potential quantum-mechanical states. When the state of a qubit is physically measured, the measurement produces one of two different basis states resolved from the state of the qubit. Thus, a single qubit can represent a one, a zero, or any quantum superposition of those two qubit states; a pair of qubits can be in any quantum superposition of 4 orthogonal basis states; and three qubits can be in any superposition of 8 orthogonal basis states. The function that defines the quantum-mechanical states of a qubit is known as its wavefunction. The wavefunction also specifies the probability distribution of outcomes for a given measurement. A qubit, which has a quantum state of dimension two (i.e., has two orthogonal basis states), may be generalized to a d-dimensional “qudit,” where d may be any integral value, such as 2, 3, 4, or higher. In the general case of a qudit, measurement of the qudit produces one of d different basis states resolved from the state of the qudit. Any reference herein to a qubit should be understood to refer more generally to an d-dimensional qudit with any value of d.

Although certain descriptions of qubits herein may describe such qubits in terms of their mathematical properties, each such qubit may be implemented in a physical medium in any of a variety of different ways. Examples of such physical media include superconducting material, trapped ions, photons, optical cavities, individual electrons trapped within quantum dots, point defects in solids (e.g., phosphorus donors in silicon or nitrogen-vacancy centers in diamond), molecules (e.g., alanine, vanadium complexes), or aggregations of any of the foregoing that exhibit qubit behavior, that is, comprising quantum states and transitions therebetween that can be controllably induced or detected.

For any given medium that implements a qubit, any of a variety of properties of that medium may be chosen to implement the qubit. For example, if electrons are chosen to implement qubits, then the x component of its spin degree of freedom may be chosen as the property of such electrons to represent the states of such qubits. Alternatively, the y component, or the z component of the spin degree of freedom may be chosen as the property of such electrons to represent the state of such qubits. This is merely a specific example of the general feature that for any physical medium that is chosen to implement qubits, there may be multiple physical degrees of freedom (e.g., the x, y, and z components in the electron spin example) that may be chosen to represent 0 and 1. For any particular degree of freedom, the physical medium may controllably be put in a state of superposition, and measurements may then be taken in the chosen degree of freedom to obtain readouts of qubit values.

Certain implementations of quantum computers, referred as gate model quantum computers, comprise quantum gates. In contrast to classical gates, there is an infinite number of possible single-qubit quantum gates that change the state vector of a qubit. Changing the state of a qubit state vector typically is referred to as a single-qubit rotation, and may also be referred to herein as a state change or a single-qubit quantum-gate operation. A rotation, state change, or single-qubit quantum-gate operation may be represented mathematically by a unitary 2×2 matrix with complex elements. A rotation corresponds to a rotation of a qubit state within its Hilbert space, which may be conceptualized as a rotation of the Bloch sphere. (As is well-known to those having ordinary skill in the art, the Bloch sphere is a geometrical representation of the space of pure states of a qubit.) Multi-qubit gates alter the quantum state of a set of qubits. For example, two-qubit gates rotate the state of two qubits as a rotation in the four-dimensional Hilbert space of the two qubits. (As is well-known to those having ordinary skill in the art, a Hilbert space is an abstract vector space possessing the structure of an inner product that allows length and angle to be measured. Furthermore, Hilbert spaces are complete: there are enough limits in the space to allow the techniques of calculus to be used.)

A quantum circuit may be specified as a sequence of quantum gates. As described in more detail below, the term “quantum gate,” as used herein, refers to the application of a gate control signal (defined below) to one or more qubits to cause those qubits to undergo certain physical transformations and thereby to implement a logical gate operation. To conceptualize a quantum circuit, the matrices corresponding to the component quantum gates may be multiplied together in the order specified by the gate sequence to produce a 2ⁿX2ⁿ complex matrix representing the same overall state change on n qubits. A quantum circuit may thus be expressed as a single resultant operator. However, designing a quantum circuit in terms of constituent gates allows the design to conform to a standard set of gates, and thus enable greater ease of deployment. A quantum circuit thus corresponds to a design for actions taken upon the physical components of a quantum computer.

A given variational quantum circuit may be parameterized in a suitable device-specific manner. More generally, the quantum gates making up a quantum circuit may have an associated plurality of tuning parameters. For example, in embodiments based on optical switching, tuning parameters may correspond to the angles of individual optical elements.

In certain embodiments of quantum circuits, the quantum circuit includes both one or more gates and one or more measurement operations. Quantum computers implemented using such quantum circuits are referred to herein as implementing “measurement feedback.” For example, a quantum computer implementing measurement feedback may execute the gates in a quantum circuit and then measure only a subset (i.e., fewer than all) of the qubits in the quantum computer, and then decide which gate(s) to execute next based on the outcome(s) of the measurement(s). In particular, the measurement(s) may indicate a degree of error in the gate operation(s), and the quantum computer may decide which gate(s) to execute next based on the degree of error. The quantum computer may then execute the gate(s) indicated by the decision. This process of executing gates, measuring a subset of the qubits, and then deciding which gate(s) to execute next may be repeated any number of times. Measurement feedback may be useful for performing quantum error correction, but is not limited to use in performing quantum error correction. For every quantum circuit, there is an error-corrected implementation of the circuit with or without measurement feedback.

Some embodiments described herein generate, measure, or utilize quantum states that approximate a target quantum state (e.g., a ground state of a Hamiltonian). As will be appreciated by those trained in the art, there are many ways to quantify how well a first quantum state “approximates” a second quantum state. In the following description, any concept or definition of approximation known in the art may be used without departing from the scope hereof. For example, when the first and second quantum states are represented as first and second vectors, respectively, the first quantum state approximates the second quantum state when an inner product between the first and second vectors (called the “fidelity” between the two quantum states) is greater than a predefined amount (typically labeled c). In this example, the fidelity quantifies how “close” or “similar” the first and second quantum states are to each other. The fidelity represents a probability that a measurement of the first quantum state will give the same result as if the measurement were performed on the second quantum state. Proximity between quantum states can also be quantified with a distance measure, such as a Euclidean norm, a Hamming distance, or another type of norm known in the art. Proximity between quantum states can also be defined in computational terms. For example, the first quantum state approximates the second quantum state when a polynomial time-sampling of the first quantum state gives some desired information or property that it shares with the second quantum state.

Not all quantum computers are gate model quantum computers. Embodiments of the present invention are not limited to being implemented using gate model quantum computers. As an alternative example, embodiments of the present invention may be implemented, in whole or in part, using a quantum computer that is implemented using a quantum annealing architecture, which is an alternative to the gate model quantum computing architecture. More specifically, quantum annealing (QA) is a metaheuristic for finding the global minimum of a given objective function over a given set of candidate solutions (candidate states), by a process using quantum fluctuations.

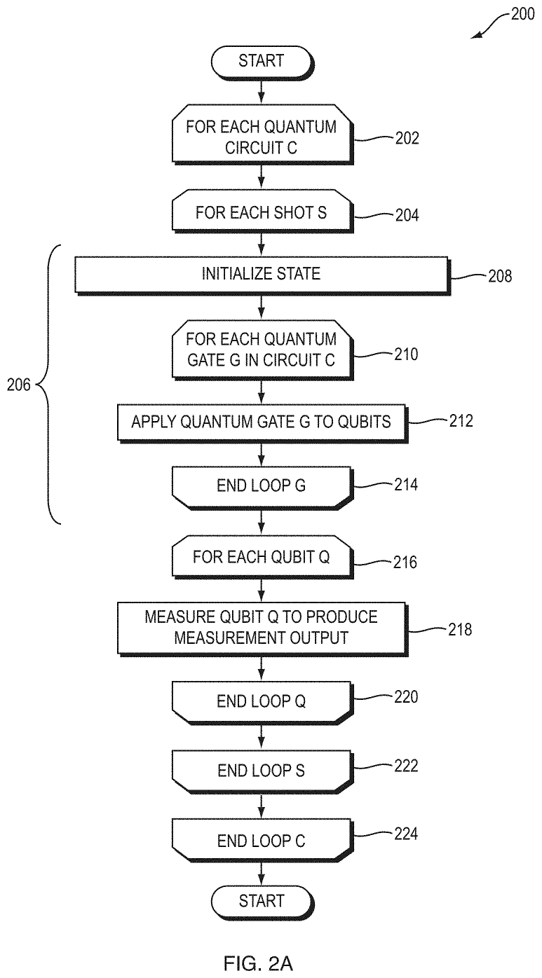

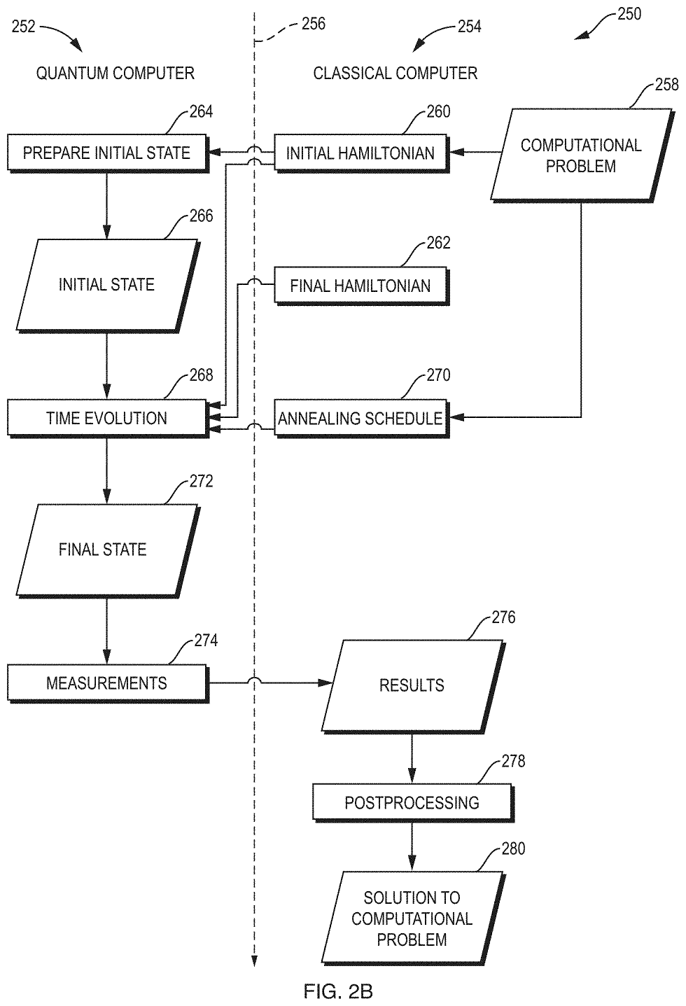

FIG. 2B shows a diagram illustrating operations typically performed by a computer system 250 which implements quantum annealing. The system 250 includes both a quantum computer 252 and a classical computer 254. Operations shown on the left of the dashed vertical line 256 typically are performed by the quantum computer 252, while operations shown on the right of the dashed vertical line 256 typically are performed by the classical computer 254.

Quantum annealing starts with the classical computer 254 generating an initial Hamiltonian 260 and a final Hamiltonian 262 based on a computational problem 258 to be solved, and providing the initial Hamiltonian 260, the final Hamiltonian 262 and an annealing schedule 270 as input to the quantum computer 252. The quantum computer 252 prepares a well-known initial state 266 (FIG. 2B, operation 264), such as a quantum-mechanical superposition of all possible states (candidate states) with equal weights, based on the initial Hamiltonian 260. The classical computer 254 provides the initial Hamiltonian 260, a final Hamiltonian 262, and an annealing schedule 270 to the quantum computer 252. The quantum computer 252 starts in the initial state 266, and evolves its state according to the annealing schedule 270 following the time-dependent Schrödinger equation, a natural quantum-mechanical evolution of physical systems (FIG. 2B, operation 268). More specifically, the state of the quantum computer 252 undergoes time evolution under a time-dependent Hamiltonian, which starts from the initial Hamiltonian 260 and terminates at the final Hamiltonian 262. If the rate of change of the system Hamiltonian is slow enough, the system stays close to the ground state of the instantaneous Hamiltonian. If the rate of change of the system Hamiltonian is accelerated, the system may leave the ground state temporarily but produce a higher likelihood of concluding in the ground state of the final problem Hamiltonian, i.e., diabatic quantum computation. At the end of the time evolution, the set of qubits on the quantum annealer is in a final state 272, which is expected to be close to the ground state of the classical Ising model that corresponds to the solution to the original optimization problem 258. An experimental demonstration of the success of quantum annealing for random magnets was reported immediately after the initial theoretical proposal.

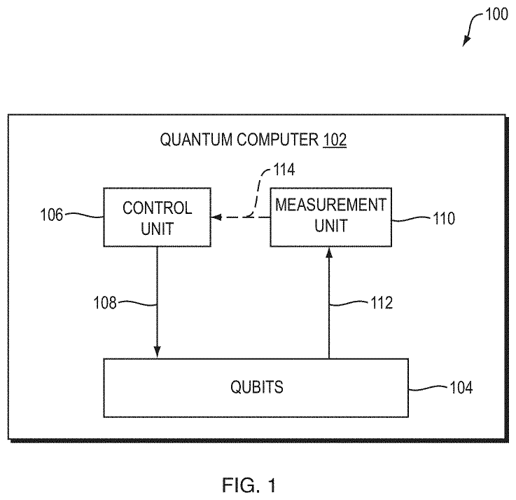

The final state 272 of the quantum computer 254 is measured, thereby producing results 276 (i.e., measurements) (FIG. 2B, operation 274). The measurement operation 274 may be performed, for example, in any of the ways disclosed herein, such as in any of the ways disclosed herein in connection with the measurement unit 110 in FIG. 1. The classical computer 254 performs postprocessing on the measurement results 276 to produce output 280 representing a solution to the original computational problem 258 (FIG. 2B, operation 278).

As yet another alternative example, embodiments of the present invention may be implemented, in whole or in part, using a quantum computer that is implemented using a one-way quantum computing architecture, also referred to as a measurement-based quantum computing architecture, which is another alternative to the gate model quantum computing architecture. More specifically, the one-way or measurement based quantum computer (MBQC) is a method of quantum computing that first prepares an entangled resource state, usually a cluster state or graph state, then performs single qubit measurements on it. It is “one-way” because the resource state is destroyed by the measurements.

The outcome of each individual measurement is random, but they are related in such a way that the computation always succeeds. In general the choices of basis for later measurements need to depend on the results of earlier measurements, and hence the measurements cannot all be performed at the same time.

Any of the functions disclosed herein may be implemented using means for performing those functions. Such means include, but are not limited to, any of the components disclosed herein, such as the computer-related components described below.

Referring to FIG. 1, a diagram is shown of a system 100 implemented according to one embodiment of the present invention. Referring to FIG. 2A, a flowchart is shown of a method 200 performed by the system 100 of FIG. 1 according to one embodiment of the present invention. The system 100 includes a quantum computer 102. The quantum computer 102 includes a plurality of qubits 104, which may be implemented in any of the ways disclosed herein. There may be any number of qubits 104 in the quantum computer 104. For example, the qubits 104 may include or consist of no more than 2 qubits, no more than 4 qubits, no more than 8 qubits, no more than 16 qubits, no more than 32 qubits, no more than 64 qubits, no more than 128 qubits, no more than 256 qubits, no more than 512 qubits, no more than 1024 qubits, no more than 2048 qubits, no more than 4096 qubits, or no more than 8192 qubits. These are merely examples, in practice there may be any number of qubits 104 in the quantum computer 102.

There may be any number of gates in a quantum circuit. However, in some embodiments the number of gates may be at least proportional to the number of qubits 104 in the quantum computer 102. In some embodiments the gate depth may be no greater than the number of qubits 104 in the quantum computer 102, or no greater than some linear multiple of the number of qubits 104 in the quantum computer 102 (e.g., 2, 3, 4, 5, 6, or 7).

The qubits 104 may be interconnected in any graph pattern. For example, they be connected in a linear chain, a two-dimensional grid, an all-to-all connection, any combination thereof, or any subgraph of any of the preceding.

As will become clear from the description below, although element 102 is referred to herein as a “quantum computer,” this does not imply that all components of the quantum computer 102 leverage quantum phenomena. One or more components of the quantum computer 102 may, for example, be classical (i.e., non-quantum components) components which do not leverage quantum phenomena.

The quantum computer 102 includes a control unit 106, which may include any of a variety of circuitry and/or other machinery for performing the functions disclosed herein. The control unit 106 may, for example, consist entirely of classical components. The control unit 106 generates and provides as output one or more control signals 108 to the qubits 104. The control signals 108 may take any of a variety of forms, such as any kind of electromagnetic signals, such as electrical signals, magnetic signals, optical signals (e.g., laser pulses), or any combination thereof.

For example:
In embodiments in which some or all of the qubits 104 are implemented as photons (also referred to as a “quantum optical” implementation) that travel along waveguides, the control unit 106 may be a beam splitter (e.g., a heater or a mirror), the control signals 108 may be signals that control the heater or the rotation of the mirror, the measurement unit 110 may be a photodetector, and the measurement signals 112 may be photons.
In embodiments in which some or all of the qubits 104 are implemented as charge type qubits (e.g., transmon, X-mon, G-mon) or flux-type qubits (e.g., flux qubits, capacitively shunted flux qubits) (also referred to as a “circuit quantum electrodynamic” (circuit QED) implementation), the control unit 106 may be a bus resonator activated by a drive, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as superconducting circuits, the control unit 106 may be a circuit QED-assisted control unit or a direct capacitive coupling control unit or an inductive capacitive coupling control unit, the control signals 108 may be cavity modes, the measurement unit 110 may be a second resonator (e.g., a low-Q resonator), and the measurement signals 112 may be voltages measured from the second resonator using dispersive readout techniques.
In embodiments in which some or all of the qubits 104 are implemented as trapped ions (e.g., electronic states of, e.g., magnesium ions), the control unit 106 may be a laser, the control signals 108 may be laser pulses, the measurement unit 110 may be a laser and either a CCD or a photodetector (e.g., a photomultiplier tube), and the measurement signals 112 may be photons.
In embodiments in which some or all of the qubits 104 are implemented using nuclear magnetic resonance (NMR) (in which case the qubits may be molecules, e.g., in liquid or solid form), the control unit 106 may be a radio frequency (RF) antenna, the control signals 108 may be RF fields emitted by the RF antenna, the measurement unit 110 may be another RF antenna, and the measurement signals 112 may be RF fields measured by the second RF antenna.
In embodiments in which some or all of the qubits 104 are implemented as nitrogen-vacancy centers (NV centers), the control unit 106 may, for example, be a laser, a microwave antenna, or a coil, the control signals 108 may be visible light, a microwave signal, or a constant electromagnetic field, the measurement unit 110 may be a photodetector, and the measurement signals 112 may be photons.
In embodiments in which some or all of the qubits 104 are implemented as two-dimensional quasiparticles called “anyons” (also referred to as a “topological quantum computer” implementation), the control unit 106 may be nanowires, the control signals 108 may be local electrical fields or microwave pulses, the measurement unit 110 may be superconducting circuits, and the measurement signals 112 may be voltages.
In embodiments in which some or all of the qubits 104 are implemented as semiconducting material (e.g., nanowires), the control unit 106 may be microfabricated gates, the control signals 108 may be RF or microwave signals, the measurement unit 110 may be microfabricated gates, and the measurement signals 112 may be RF or microwave signals.

Although not shown explicitly in FIG. 1 and not required, the measurement unit 110 may provide one or more feedback signals 114 to the control unit 106 based on the measurement signals 112. For example, quantum computers referred to as “one-way quantum computers” or “measurement-based quantum computers” utilize such feedback 114 from the measurement unit 110 to the control unit 106. Such feedback 114 is also necessary for the operation of fault-tolerant quantum computing and error correction.

The control signals 108 may, for example, include one or more state preparation signals which, when received by the qubits 104, cause some or all of the qubits 104 to change their states. Such state preparation signals constitute a quantum circuit also referred to as an “ansatz circuit.” The resulting state of the qubits 104 is referred to herein as an “initial state” or an “ansatz state.” The process of outputting the state preparation signal(s) to cause the qubits 104 to be in their initial state is referred to herein as “state preparation” (FIG. 2A, section 206). A special case of state preparation is “initialization,” also referred to as a “reset operation,” in which the initial state is one in which some or all of the qubits 104 are in the “zero” state i.e. the default single-qubit state. More generally, state preparation may involve using the state preparation signals to cause some or all of the qubits 104 to be in any distribution of desired states. In some embodiments, the control unit 106 may first perform initialization on the qubits 104 and then perform preparation on the qubits 104, by first outputting a first set of state preparation signals to initialize the qubits 104, and by then outputting a second set of state preparation signals to put the qubits 104 partially or entirely into non-zero states.

Another example of control signals 108 that may be output by the control unit 106 and received by the qubits 104 are gate control signals. The control unit 106 may output such gate control signals, thereby applying one or more gates to the qubits 104. Applying a gate to one or more qubits causes the set of qubits to undergo a physical state change which embodies a corresponding logical gate operation (e.g., single-qubit rotation, two-qubit entangling gate or multi-qubit operation) specified by the received gate control signal. As this implies, in response to receiving the gate control signals, the qubits 104 undergo physical transformations which cause the qubits 104 to change state in such a way that the states of the qubits 104, when measured (see below), represent the results of performing logical gate operations specified by the gate control signals. The term “quantum gate,” as used herein, refers to the application of a gate control signal to one or more qubits to cause those qubits to undergo the physical transformations described above and thereby to implement a logical gate operation.

It should be understood that the dividing line between state preparation (and the corresponding state preparation signals) and the application of gates (and the corresponding gate control signals) may be chosen arbitrarily. For example, some or all the components and operations that are illustrated in FIGS. 1 and 2A-2B as elements of “state preparation” may instead be characterized as elements of gate application. Conversely, for example, some or all of the components and operations that are illustrated in FIGS. 1 and 2A-2B as elements of “gate application” may instead be characterized as elements of state preparation. As one particular example, the system and method of FIGS. 1 and 2A-2B may be characterized as solely performing state preparation followed by measurement, without any gate application, where the elements that are described herein as being part of gate application are instead considered to be part of state preparation. Conversely, for example, the system and method of FIGS. 1 and 2A-2B may be characterized as solely performing gate application followed by measurement, without any state preparation, and where the elements that are described herein as being part of state preparation are instead considered to be part of gate application.

The quantum computer 102 also includes a measurement unit 110, which performs one or more measurement operations on the qubits 104 to read out measurement signals 112 (also referred to herein as “measurement results”) from the qubits 104, where the measurement results 112 are signals representing the states of some or all of the qubits 104. In practice, the control unit 106 and the measurement unit 110 may be entirely distinct from each other, or contain some components in common with each other, or be implemented using a single unit (i.e., a single unit may implement both the control unit 106 and the measurement unit 110). For example, a laser unit may be used both to generate the control signals 108 and to provide stimulus (e.g., one or more laser beams) to the qubits 104 to cause the measurement signals 112 to be generated.

In general, the quantum computer 102 may perform various operations described above any number of times. For example, the control unit 106 may generate one or more control signals 108, thereby causing the qubits 104 to perform one or more quantum gate operations. The measurement unit 110 may then perform one or more measurement operations on the qubits 104 to read out a set of one or more measurement signals 112. The measurement unit 110 may repeat such measurement operations on the qubits 104 before the control unit 106 generates additional control signals 108, thereby causing the measurement unit 110 to read out additional measurement signals 112 resulting from the same gate operations that were performed before reading out the previous measurement signals 112. The measurement unit 110 may repeat this process any number of times to generate any number of measurement signals 112 corresponding to the same gate operations. The quantum computer 102 may then aggregate such multiple measurements of the same gate operations in any of a variety of ways.

After the measurement unit 110 has performed one or more measurement operations on the qubits 104 after they have performed one set of gate operations, the control unit 106 may generate one or more additional control signals 108, which may differ from the previous control signals 108, thereby causing the qubits 104 to perform one or more additional quantum gate operations, which may differ from the previous set of quantum gate operations. The process described above may then be repeated, with the measurement unit 110 performing one or more measurement operations on the qubits 104 in their new states (resulting from the most recently-performed gate operations).

In general, the system 100 may implement a plurality of quantum circuits as follows. For each quantum circuit C in the plurality of quantum circuits (FIG. 2A, operation 202), the system 100 performs a plurality of “shots” on the qubits 104. The meaning of a shot will become clear from the description that follows. For each shot S in the plurality of shots (FIG. 2A, operation 204), the system 100 prepares the state of the qubits 104 (FIG. 2A, section 206). More specifically, for each quantum gate G in quantum circuit C (FIG. 2A, operation 210), the system 100 applies quantum gate G to the qubits 104 (FIG. 2A, operations 212 and 214).

Then, for each of the qubits Q 104 (FIG. 2A, operation 216), the system 100 measures the qubit Q to produce measurement output representing a current state of qubit Q (FIG. 2A, operations 218 and 220).

The operations described above are repeated for each shot S (FIG. 2A, operation 222), and circuit C (FIG. 2A, operation 224). As the description above implies, a single “shot” involves preparing the state of the qubits 104 and applying all of the quantum gates in a circuit to the qubits 104 and then measuring the states of the qubits 104; and the system 100 may perform multiple shots for one or more circuits.

Referring to FIG. 3, a diagram is shown of a hybrid classical quantum computer (HQC) 300 implemented according to one embodiment of the present invention. The HQC 300 includes a quantum computer component 102 (which may, for example, be implemented in the manner shown and described in connection with FIG. 1) and a classical computer component 306. The classical computer component may be a machine implemented according to the general computing model established by John Von Neumann, in which programs are written in the form of ordered lists of instructions and stored within a classical (e.g., digital) memory 310 and executed by a classical (e.g., digital) processor 308 of the classical computer. The memory 310 is classical in the sense that it stores data in a storage medium in the form of bits, which have a single definite binary state at any point in time. The bits stored in the memory 310 may, for example, represent a computer program. The classical computer component 304 typically includes a bus 314. The processor 308 may read bits from and write bits to the memory 310 over the bus 314. For example, the processor 308 may read instructions from the computer program in the memory 310, and may optionally receive input data 316 from a source external to the computer 302, such as from a user input device such as a mouse, keyboard, or any other input device. The processor 308 may use instructions that have been read from the memory 310 to perform computations on data read from the memory 310 and/or the input 316, and generate output from those instructions. The processor 308 may store that output back into the memory 310 and/or provide the output externally as output data 318 via an output device, such as a monitor, speaker, or network device.

The quantum computer component 102 may include a plurality of qubits 104, as described above in connection with FIG. 1. A single qubit may represent a one, a zero, or any quantum superposition of those two qubit states. The classical computer component 304 may provide classical state preparation signals Y32 to the quantum computer 102, in response to which the quantum computer 102 may prepare the states of the qubits 104 in any of the ways disclosed herein, such as in any of the ways disclosed in connection with FIGS. 1 and 2A-2B.

Once the qubits 104 have been prepared, the classical processor 308 may provide classical control signals Y34 to the quantum computer 102, in response to which the quantum computer 102 may apply the gate operations specified by the control signals Y32 to the qubits 104, as a result of which the qubits 104 arrive at a final state. The measurement unit 110 in the quantum computer 102 (which may be implemented as described above in connection with FIGS. 1 and 2A-2B) may measure the states of the qubits 104 and produce measurement output Y38 representing the collapse of the states of the qubits 104 into one of their eigenstates. As a result, the measurement output Y38 includes or consists of bits and therefore represents a classical state. The quantum computer 102 provides the measurement output Y38 to the classical processor 308. The classical processor 308 may store data representing the measurement output Y38 and/or data derived therefrom in the classical memory 310.

The steps described above may be repeated any number of times, with what is described above as the final state of the qubits 104 serving as the initial state of the next iteration. In this way, the classical computer 304 and the quantum computer 102 may cooperate as co-processors to perform joint computations as a single computer system.

Although certain functions may be described herein as being performed by a classical computer and other functions may be described herein as being performed by a quantum computer, these are merely examples and do not constitute limitations of the present invention. A subset of the functions which are disclosed herein as being performed by a quantum computer may instead be performed by a classical computer. For example, a classical computer may execute functionality for emulating a quantum computer and provide a subset of the functionality described herein, albeit with functionality limited by the exponential scaling of the simulation. Functions which are disclosed herein as being performed by a classical computer may instead be performed by a quantum computer.

The techniques described above may be implemented, for example, in hardware, in one or more computer programs tangibly stored on one or more computer-readable media, firmware, or any combination thereof, such as solely on a quantum computer, solely on a classical computer, or on a hybrid classical quantum (HQC) computer. The techniques disclosed herein may, for example, be implemented solely on a classical computer, in which the classical computer emulates the quantum computer functions disclosed herein.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention use a hybrid quantum-classical computer to perform Bayesian phase estimation, which would be infeasible or impossible to perform manually on anything other than trivial problems.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

What is claimed is:

1. A method performed by a hybrid quantum-classical computer, the hybrid quantum-classical computer comprising a classical computer and a quantum computer, the method comprising:
(A) on the classical computer, transforming an initial problem description of an initial problem into a transformed problem description of a transformed problem of estimating an expectation value of a function of random variables;
(B) on the classical computer, producing computer program instructions representing a Bayesian phase estimation scheme for solving the transformed problem; and
(C) on the hybrid quantum-classical computer, executing the computer program instructions to execute the Bayesian phase estimation scheme to produce an estimate of the expectation value of the function of random variables.

2. The method of claim 1, wherein (B) comprises incorporating, into the Bayesian phase estimation scheme, a model for an effect of error on the hybrid quantum-classical computer.

3. The method of claim 1, wherein the initial problem description comprises a description of a Monte Carlo sampling problem, and wherein transforming the initial problem description comprises transforming the description of the Monte Carlo sampling problem into the transformed problem description.

4. The method of claim 3, wherein the initial problem description comprises a description of a problem of credit valuation adjustment, and wherein transforming the initial problem description comprises transforming the description of the Monte Carlo sampling problem into the transformed problem description.

5. The method of claim 1, wherein the transforming comprises encoding the initial problem description via a binary encoding.

6. The method of claim 5, wherein the initial problem description comprises a description of a travelling salesman problem, and wherein transforming the initial problem description comprises transforming the description of the travelling salesman problem into the transformed problem description.

7. The method of claim 1, wherein the initial problem description comprises a description of a quadratic unconstrained binary optimization problem, and wherein transforming the initial problem description comprises transforming the description of the quadratic unconstrained binary optimization problem into the transformed problem description.

8. The method of claim 7, wherein the initial problem description comprises a description of a problem of feature selection, and wherein transforming the initial problem description comprises transforming the description of the quadratic unconstrained binary optimization problem into the transformed problem description.

9. The method of claim 7, wherein (C) comprises:
(C)(1) at the quantum computer, computing, using a distance measure, a distance between two data arrays;
(C)(2) at the quantum computer, constructing an Ising Hamiltonian whose ground state encodes a minimally redundant subset with respect to the distance measure; and
(C)(3) obtaining the optimal subset.

10. The method of claim 9, wherein obtaining the optimal subset is performed by the quantum computer and not the classical computer.

11. The method of claim 9, wherein obtaining the optimal subset is performed by the classical computer and not the quantum computer.

12. A hybrid quantum-classical (HQC) computer comprising:
a classical computer; and
a quantum computer,
wherein the classical computer comprises at least one processor and at least one non-transitory computer-readable medium having first computer program instructions stored thereon, wherein the first computer program instructions are executable by the at least one processor to perform a method, the method comprising:
(A) transforming an initial problem description of an initial problem into a transformed problem description of a transformed problem of estimating an expectation value of a function of random variables; and
(B) producing second computer program instructions representing a Bayesian phase estimation scheme for solving the transformed problem; and
wherein the HQC computer is adapted to execute the second computer program instructions to execute the Bayesian phase estimation scheme to produce an estimate of the expectation value of the function of random variables.

13. The HQC computer of claim 12, wherein (B) comprises incorporating, into the Bayesian phase estimation scheme, a model for an effect of error on the hybrid quantum-classical computer.

14. The HQC computer of claim 12, wherein the initial problem description comprises a description of a Monte Carlo sampling problem, and wherein transforming the initial problem description comprises transforming the description of the Monte Carlo sampling problem into the transformed problem description.

15. The HQC computer of claim 14, wherein the initial problem description comprises a description of a problem of credit valuation adjustment, and wherein transforming the initial problem description comprises transforming the description of the Monte Carlo sampling problem into the transformed problem description.

16. The HQC computer of claim 12, wherein the transforming comprises encoding the initial problem description via a binary encoding.

17. The HQC computer of claim 16, wherein the initial problem description comprises a description of a travelling salesman problem, and wherein transforming the initial problem description comprises transforming the description of the travelling salesman problem into the transformed problem description.

18. The HQC computer of claim 12, wherein the initial problem description comprises a description of a quadratic unconstrained binary optimization problem, and wherein transforming the initial problem description comprises transforming the description of the quadratic unconstrained binary optimization problem into the transformed problem description.

19. The HQC computer of claim 18, wherein the initial problem description comprises a description of a problem of feature selection, and wherein transforming the initial problem description comprises transforming the description of the quadratic unconstrained binary optimization problem into the transformed problem description.

20. The HQC computer of claim 18, wherein the HQC computer is adapted to execute the second computer program instructions to execute the Bayesian phase estimation scheme by:
computing, using a distance measure, a distance between two data arrays; and
constructing an Ising Hamiltonian whose ground state encodes a minimally redundant subset with respect to the distance measure; and
wherein the HQC computer is adapted to obtain the optimal subset.

21. The HQC computer of claim 20, wherein the quantum computer, and not the classical computer, is adapted to obtain the optimal subset.

22. The HQC computer of claim 20, wherein the classical computer, and not the quantum computer, is adapted to obtain the optimal subset.

23. A method performed by a hybrid quantum-classical computer, the hybrid quantum-classical computer comprising a classical computer and a quantum computer, the method for use with a transformed problem description of a problem of estimating an expectation value of a function of random variables, wherein the transformed problem description was generated by transforming an initial problem description of an initial problem into the transformed problem description, comprising:
(A) executing computer program instructions, the computer program instructions representing a Bayesian phase estimation scheme for solving the transformed problem, to execute the Bayesian phase estimation scheme to produce an estimate of the expectation value of the function of random variables.

24. A hybrid quantum-classical (HQC) computer comprising:
a classical computer, the classical computer including:
a processor; and
a non-transitory computer-readable medium comprising computer program instructions representing a Bayesian phase estimation scheme for solving a transformed problem of estimating an expectation value of a function of random variables;
a quantum computer,
wherein the HQC computer is adapted to execute the computer program instructions to execute the Bayesian phase estimation scheme to produce an estimate of the expectation value of the function of random variables.
